(19) United States
(12) Patent Application Publication
(10) Pub. No.: US 2021/0293401 A1
(43) Pub. Date: Sep. 23, 2021

(54) LIGHTED DRAWER, LIGHTING DEVICE AND CURRENT COLLECTOR

(71) Applicant: OBSCHESTVO S OGRANICHENNOY OTVETSTVENNOSTU COMPANIA "NORKPALM", Moscow (RU)

(72) Inventors: Petr Nikolaevich VOLKOV, Moscow (RU); Vladimir Livovich BANDAREV, Moscow (RU)

(73) Assignee: OOO Compania "NorkPalm", Moscow (RU)

(21) Appl. No.: 14/435,742

(22) PCT Filed: Dec. 18, 2012
(86) PCT No.: PCT/RU2012/001080

§ 371 Date: Feb. 19, 2016

(30) Foreign Application Priority Data
Oct. 22, 2012 (RU) 2012144703
Nov. 9, 2012 (RU) 2012147700

(51) Int. Cl. F21V 23/04; F25D 25/02; A47B 95/00; A47B 96/00; F21V 23/06; F21V 33/00; F21S 4/00

(52) U.S. Cl. CPC F21V 23/04; F25D 25/025; A47B 95/00; A47B 96/00; F21Y 2103/003; F21V 33/0012; F21S 4/008; A47B 2220/0077; F21V 23/06

(57) ABSTRACT

The invention relates to a drawer with side walls and a base, having an improved drawer lighting device and a current collector therefor, and provides for simplified installation and maintenance. The drawer comprises a lighting device with an LED strip of a given length mounted on a side wall of the drawer, and a current collector electrically connected to the LED strip and having spring-loaded contacts for cooperation with electrically conductive elements which are connected to a power supply. The current collector has a housing in which the aforementioned spring-loaded contacts are movably disposed. When extended beyond the housing, the spring-loaded contacts enable electrical contact with the aforementioned electrically conductive elements, which are mounted on the structure of the furniture component relative to which the drawer is able to move. The invention increases the functional capabilities of the structure by means of the activation of lighting.

The invention relates to a sliding drawers, the backlight unit and the current collector drawer for a drawer of the lighting device.

The drawer comprises a bottom, a front panel, a rear wall located opposite the front panel, and two side walls extending in a conveyance direction of the box and made in the form of hollow profile sections, which are fixedly connected to the end portions of the rear wall. Known construction sliding drawers patent RU 2424754, which discloses a drawer comprising a bottom, a front panel, a rear wall located opposite the front panel is in the form of hollow profile sections, and two lateral walls extending in the direction of travel of the drawer and adapted in the form of hollow profile sections, which are fixedly connected to the end portions of the rear wall. The disadvantage of this box is the inability to mount it in the backlight.

Also known retractable drawers backlit see. RU Patent 2402252, which describes the profile box, having in its design a light source. To realize the function of the backlight corresponding to the profiled functional strip is produced with a plurality of chambers having at least two open on one side of the chamber, wherein the chamber is formed as a connecting chamber box includes components, and the other chamber is open to accommodate the light source and comprising one or more light sources. A camera comprising light sources and arranged so that the light rays are directed into the box. Preferably, the LED light source is used, since these elements are extremely compact and require a very small power consumption.

To protect these light sources comprising a light source chamber include at least one fixing rib for fixing cover strips made of a transparent material. As a result, the light sources are optimally protected and, in spite of this, ensure optimum illumination of the interior. Using the fixing ribs ensures simple assembly and dismantling and requires no additional fasteners such as screws. The disadvantage of this solution is the difficulty of manufacturing, assembly and service design box with illumination. Task that underlies the present invention is to provide a universal design of the lighting device and a current collector for drawers with easy installation and maintenance.

To solve this problem is proposed with four drawer lateral generators bottom and the illumination. In this backlight device comprising a light source mounted at least on one side of the box forming, a current collector electrically connected to the light source, and having a spring-loaded contacts for cooperation with the conductive elements connected to a power supply. The current collector has a housing with a movably mounted within the said housing a spring-loaded contacts, providing at the nomination of their body electrical contact with said conductive elements, installed in a furniture design element, relative to which the drawer is movable. There are two alternatives for the extension of these spring-loaded contacts from the body of the current collector. According to a first embodiment of the extension spring loaded contacts provided by the magnetic force produced by reacting at least one magnetic member structurally associated with said spring-loaded contacts in the housing of the current collector with at least one metallic or magnetic element having predetermined dimensions, and installed in conjunction with said conductive elements so as to move with respect to the structure of the drawer of the furniture element in which it is installed, said spring-loaded contacts collector brought into contact with said conductive elements having a predetermined length.

According to a second alternative embodiment, which is the most simple, spring-loaded contacts said extension of the current collector housing is provided only through the mechanical action of the spring, so that when moving the drawer relative to the element of the furniture structure in which it is installed, said spring-loaded contacts the current collector is contacted with the said conductive elements having a predetermined length. In this case the spring-loaded contacts are always pushed out of the housing of the current collector due to the mechanical action of the spring. However, in this case the spring may come loose over time and need to be replaced. When using the magnet design the most durable. The light source is preferably an LED ribbon predetermined length. Conductive elements are usually connected to a power source (mains) through a transformer.

Forming the drawer side can be carried out as a continuous wall of the groove on the inner side, wherein the light source is installed. When forming this side of the drawer is preferably a metal profile, in particular of aluminum, which facilitates and simplifies the design of the box making it. Usually, the generators are made in the side walls form, with a single groove into which the bottom of the box.

Advantageously, the metallic or magnetic element for interacting with the magnet of the current collector was formed integrally with the conductive elements. In particular, conductive elements may themselves serve metallic or magnetic element for interacting with the magnet of the current collector, or be deposited on such elements.

Conductive elements may be isolated from a metallic or magnetic element serving for interacting with the magnet of the current collector. Conductive elements may comprise portions of the insulator to avoid contact with spring contacts. Preferably, the conductive elements are formed as plates.

Also proposed illumination device of the drawer which comprises a light source mounted at least on one side of the box forming, a current collector electrically connected to the light source, and having a spring-loaded contacts for cooperation with the conductive elements connected to a power supply.

Wherein the current collector has a housing with a movable body mounted inside the said spring-loaded contacts, providing them with nomination of body electrical contact with said conductive elements, installed in a furniture design element, relative to which the drawer is movable. Extension of said spring-loaded contacts from the housing of the current collector is provided either by the magnetic force produced by reacting at least one magnetic member structurally associated with said spring-loaded contacts in the housing of the current collector with at least one metallic or magnetic element having predetermined dimensions and installed together with the said conductive elements so as to move with respect to the structure of the drawer of the furniture element in which it is installed, said spring-loaded contacts collector brought into contact with said conductive elements. Or extension of said spring-loaded contacts from the body of the current collector is provided without the use of a magnet, ie in its absence in the housing of the current collector, namely, only by the mechanical action of the spring, so that when moving the drawer relative to the element of the furniture structure in which it is installed, said spring-loaded contacts collector brought into contact with said conductive elements having a predetermined length.

The light source is typically a LED ribbon predetermined length. Metallic or magnetic element for interacting with the magnet of the current collector may be integrally formed with the conductive elements. Conductive elements may be isolated from a metallic or magnetic element serving for interacting with the magnet of the current collector. Of greatest interest is the proposed construction of the current collector for the illumination device of the drawer, which is made in the body, contains contacts for electrical connection to the light source, as well as spring-loaded terminals to interact with separate disposable conductive elements are connected to the power source, said spring-loaded pins slidably mounted within the housing so that their extension is provided from the housing for electrical contact with said conductive elements, installed in a furniture construction element with respect to which the drawer is movable. As mentioned above, the extension of said spring-loaded contacts from the housing of the current collector can be achieved by a magnetic force generated by the interaction of at least one magnetic member structurally associated with said spring-loaded contacts in the housing of the current collector with at least one metallic element having predetermined dimensions and installed together with the said conductive elements so as to move with respect to the structure of the drawer of the furniture element in which it is installed, said spring-loaded contacts collector brought into contact with said conductive elements. According to an alternative embodiment of the spring-loaded contacts said extension of the housing of the current collector is provided by the mechanical action of the spring only, without the presence of the magnet so that when the drawer is moved relative to the design of the furniture element in which it is installed, said spring-loaded contacts collector brought into contact with said conductive elements having a predetermined length.

The light source may be a LED strip. Spring-loaded contacts may be provided with the function of the magnetic member or a magnetic member may be a part of the contact. The magnetic element may be a magnet mounted on one block with spring contacts. Advantageously, the housing of the current collector was made demountable and comprises a means for fixing the drawer. Typically, the spring-loaded contacts have the ability to adjust the length of parts put forward, for example, spring loaded contacts may be provided with the stopper in the housing extension to a predetermined length.

The main differences and advantages of the proposed technical solutions are as follows: —can be used aluminum profile with pre-grooves in which the elements can be mounted lighting box (LED strip) and inlays. The design of the lighting device for fast and easy installation, and ease of maintenance. The possibility of using LED lighting as well as the mechanical side location, lighting can be installed around the perimeter of the box without any additional current collectors, both inside and outside the box. Current collector has a wireless connection to the lighting device and has the ability to self-aligning when properly installed in a cabinet drawer on the rails with respect to the conductive elements. Universal application of the proposed design of the lighting device with the current collector for any roll-out/pull-out drawer systems, including kitchen cabinets, wardrobes, laboratory cabinets, cabinets for papers. For the application of the proposed collector there are no restrictions on the design and shape of a box. Through the use of profile having grooves in which are mounted inlays and elements highlight box, a high aesthetic quality of the box, as well as the possibility of using the box in the dim and dark rooms. Through the use of simple design profile having slots, reduces the cost of the product and thus the final price of the box. Due to a simple and at the same time innovative design elements box made fast and easy mounting box.

For minimum weight and improve the aesthetics of the drawer is preferable to perform its generators (profile) of aluminum. The bottom of the box may be made of any material and have any thickness, in particular: 4, 8, 10 and 16 mm. The side walls of the box may contain elements of MDF, glass, plastic and other materials used in the furniture industry. For fixing the box in the bottom preferably connected to two side walls and rear wall have a single groove into which the bottom of the box.

As proposed embodiment comprises a drawer bottom, a front panel, a rear wall located opposite the front panel is preferably made in the form of hollow profile sections, and two lateral walls extending in the direction of travel of the drawer and is also preferably made in the form of hollow profile sections, which fixedly connected to the end portions of the rear wall. In the side profile groove formed to insert the LED strip connector connected to the bill box with movable electric plug (current collector) located, for example, in the rear wall. At the end of the electrical plug (collector contact) is located at least one spring-loaded magnet that allows the nomination drawer electrical plug contact (collector contact) with a contact in the form of metal (steel or copper) strips insulated from each other mounted on the side furniture and wall connected to the mains. Electrical connection preferably via a transformer outputs a voltage of 12V.

The groove in which the LED strip is attached, can be made as to the inner side of the box, and with the outer one. Also, the groove in which the LED strip is attached, preferably transparent or translucent to close the insert, fixed in a groove, for example, by means of resilient clips or adhesive.

The essence of the proposed technical solution is illustrated by drawings.

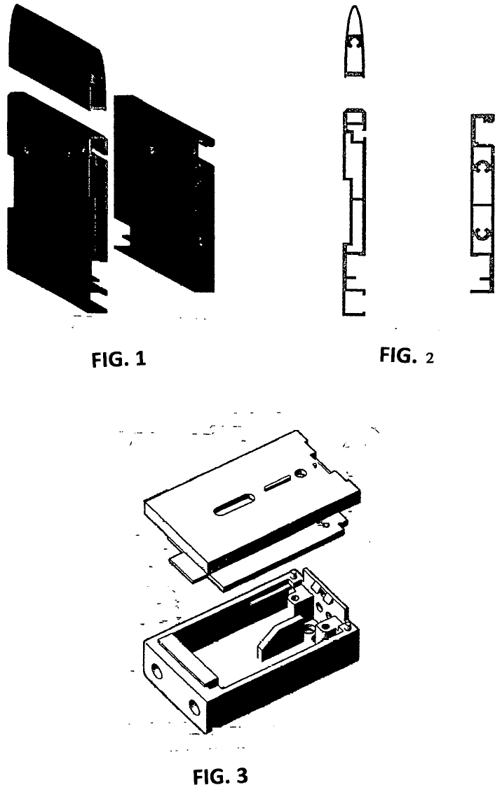

FIG. 1—Example performance aluminum extrusions drawer;

FIG. 2—cross-section profiles;

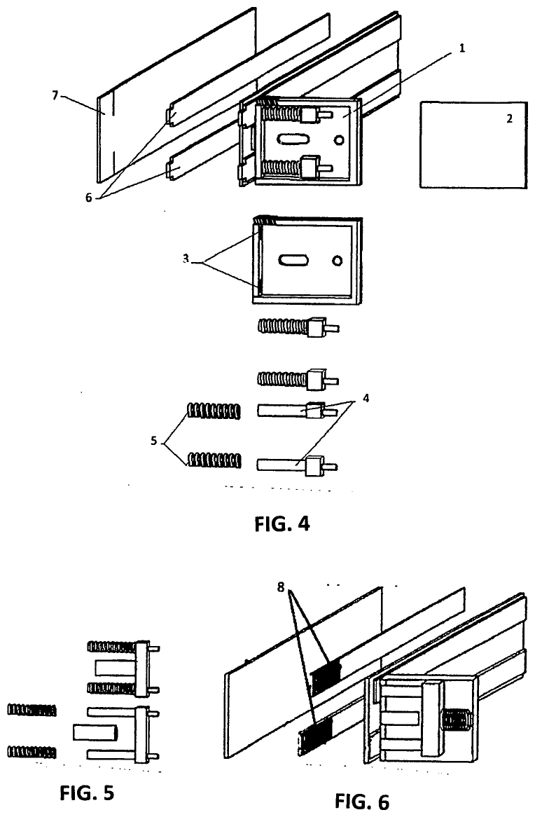

FIG. 3—The body of the current collector;

FIG. 4, 5—Examples of structural embodiment of the current collector with conductive elements and the use of a magnet; and

FIG. 6—Example of a constructive implementation of the current collector with conductive elements without the use of a magnet.

An exemplary embodiment of the present drawer with illumination. Rear and side generators (wall) of the drawer is made of aluminum profiles and bottom of the box and front part of all materials used in the manufacture of furniture. Side profiles are manufactured with built-in or join them accessories to ensure the nomination box, for example, with the use of rollers. In side profile can be provided for the insertion slot LED strip, which in the end has contacts that are connected to the current collector, located in the back of the box. The collector is formed with the housing (1) having a cover (2) and the holes (3) for the spring-loaded output contacts (4) by springs (5). Spring-loaded contacts (4) can be performed with the magnetic elements (e.g., magnetic cores), or be formed on a common substrate with separate fixed magnetic element. Springs (5) may be made of a nonmagnetic material. An alternative embodiment without using the magnet shown in FIG. 4. It is advisable to applying a layer of dielectric izolyatora—(8) on the edge of the conductive elements.

These spring-loaded terminals (4) in the nomination box shall come from the body (1) through the hole (3) by compression springs (5) under the action of the magnetic field and in contact with the conductive elements (6)—metal (steel or copper) strips fixed on the inner wall of furniture (cabinet, pedestals, etc.) in which the drawer moves. Contact occurs only at the nomination drawer from the closed position to a predetermined length, when the magnet comes into contact with a metal or a magnetic stripe (7) of predetermined length, which contributes to the magnetic attraction force and the spring-loaded contacts nomination by compression springs. Conductive elements (6) are isolated from the strip (7) to prevent an electrical short, it can be used with the adhesive or dielectric properties strip (7) can have an insulating coating at the location of the elements (6).

Each metal band corresponds to one end of the collector, wherein the metal strips are electrically insulated from each other and may function as the band (7). The light only goes out when the termination of the contact spring-loaded contacts by removing the magnetic field, ie, absence of contact between the magnetic element (s) and the corresponding metal or magnetic element when the drawer is fully closed and the current collector housing is not in contact with the conductive area element (6). Accordingly, the backlight of the drawer if and only if it is closing the drawer spring-loaded contacts came into the body of the current collector, and at the opening of the nominated body of the current collector and the contact with the conductive elements.

1. The drawer side with four generators and bottom lighting device, characterized in that the illumination device comprises a light source mounted at least on one side of the box forming, a current collector electrically connected to the light source, and having a spring-loaded contacts interaction with the conductive elements are connected to the power supply, and the current collector comprises a housing having movably mounted within the housing specified spring-loaded contacts, providing them with the nomination of the body electrical contact with said conductive elements to be installed in furniture design element with respect to which the drawer has the ability to move, extension of said spring-loaded contacts from the current collector housing is provided by the magnetic force produced by reacting at least one magnetic member structurally associated with said spring-loaded contacts in the housing of the current collector with at least one metallic or magnetic element having predetermined dimensions and installed together with the said conductive elements so as to move with respect to the structure of the drawer of the furniture element in which it is installed, said spring-loaded contacts collector brought into contact with said conductive elements having a predetermined length or extension of said spring-loaded contacts from the current collector housing is provided due to mechanical impact spring, so that when moving the drawer relative to the element of the furniture structure in which it is installed, said spring-loaded contacts collector brought into contact with said conductive elements having a predetermined length.

2. Drawer according to claim 1, characterized in that the light source is an LED strip of a given length.

3. Drawer according to claim 1, characterized in that the conductive elements are connected to the mains via a transformer.

4. Drawer according to claim 1, characterized in that the generator side of the drawer is formed as a solid wall with a groove on the inner side, wherein the light source is installed.

5. Drawer according to claim 1, characterized in that the generator side of the drawer is in the form of metal profiles, in particular aluminum.

6. Drawer according to claim 1, characterized in that the forming side walls are made as having a single groove into which the bottom of the box.

7. Drawer according to claim 1, characterized in that the metallic or magnetic element for interacting with the magnet of the current collector is formed integrally with the conductive elements.

8. Drawer according to claim 1, characterized in that the conductive elements are insulated from the metallic or magnetic element serving for interacting with the magnet of the current collector.

9. A drawer according to claim 1, characterized in that the conductive elements comprise portions of insulator to avoid contact with spring contacts.

10. A drawer according to claim 1, characterized in that the conductive elements are in the form of plates.

11. A lighting device of the drawer, characterized in that it comprises a light source mounted to at least one side forming a box, the current collector is electrically connected to the light source, and having a spring-loaded contacts for cooperation with the conductive elements connected to a power supply, wherein the current collector has a housing with a movable body mounted inside the said spring-loaded contacts, providing them with nomination of body electrical contact with said conductive elements, installed in a furniture design element, relative to which the drawer is movable, spring-loaded contacts extension of said collector housing is provided by magnetic force produced by reacting at least one magnetic member structurally associated with said spring-loaded contacts in the housing of the current collector with at least one metallic or magnetic element having predetermined dimensions and installed together with the said conductive elements so so that when the drawer is moved relative to the construction of furniture element in which it is installed, said spring-loaded contacts collector brought into contact with said conductive elements, said extension or spring-loaded contacts from the current collector housing is provided only through the mechanical action of the spring, so that when moving the drawer relation to the structural element of the furniture in which it is installed, said spring-loaded contacts collector brought into contact with said conductive elements having a predetermined length.

12. The lighting device according to claim 11, characterized in that the light source is an LED strip of a given length.

13. The lighting device according to claim 11, characterized in that the metallic or magnetic element for interacting with the magnet of the current collector is formed integrally with the conductive elements.

14. The lighting device according to claim 11, characterized in that the conductive elements are insulated from the metallic or magnetic element serving for interacting with the magnet of the current collector.

15. The current collector for the illumination device of the drawer, characterized in that configured in the housing comprises terminals for electrical connection to the light source, as well as spring-loaded contacts for interaction with a separately disposable conductive elements connected to a power supply, wherein said spring-loaded contacts movably mounted within the housing so that their extension is provided from the housing for electrical contact with said conductive elements, installed in a furniture construction element with respect to which the drawer is movable, spring-loaded contacts extension of said collector casing is provided by the magnetic force generated by interaction by at least one magnetic member structurally associated with said spring-loaded contacts in the housing of the current collector with at least one metallic element having predetermined dimensions and installed together with the said conductive elements so as to move with respect to the structure of the drawer of the furniture element, which it is installed, said spring-loaded contacts collector brought into contact with said conductive elements, said extension or spring-loaded contacts from the current collector housing is provided only through the mechanical action of the spring, so that when moving the drawer relative to the element of the furniture structure in which it is installed, said sprung collector contacts brought into contact with said conductive elements having a predetermined length.

16. The current collector of claim 15 wherein the light source is a LED strip.

17. The current collector of claim 15 wherein the spring-loaded contacts are made with the function of the magnetic element.

18. The current collector of claim 15, characterized in that the magnetic element is a magnet mounted on one block with spring contacts.

19. The current collector of claim 15 wherein the body is made collapsible.

20. The current collector of claim 15 wherein the locking means comprises a drawer.

21. The current collector of claim 15 wherein the spring-loaded contacts have the ability to adjust the length of parts nominated.

22. The current collector of claim 15 wherein the spring-loaded contacts made in the body with the stopper at a predetermined extension length.

23. The drawer comprising a bottom, a front panel, a rear wall and two side walls in the form of hollow profile sections, characterized in that the side wall a groove for inserting the LED strip connector connected to the bill collector box with movable electric plug, wherein at the end of an electric plug is arranged at least one spring-loaded magnet that allows the nomination drawer electrical contact with the plug contacts in the form of metal strips insulated from each other, fixed to the furniture side wall and connected to the mains via a transformer.
